(19) United States
(12) Patent Application Publication
(10) Pub. No.: US 2026/0279248 A1
(43) Pub. Date: Sep. 17, 2026

(54) A COMBINATION OF AN ENCLOSURE ELEMENT AND A DISPLAY DEVICE FOR REDUCING THE VISUAL TRANSITION BETWEEN VISUAL MEDIA CONTENT DISPLAYED ON A DISPLAY OF THE DISPLAY DEVICE AND THE ENVIRONMENT SURROUNDING THE DISPLAY DEVICE AS WELL AS SUCH DISPLAY DEVICE

(71) Applicant: Van Berge Henegouwen Installaties B.V., WEESP (NL)

(72) Inventors: Xavier Maurice Maximilien GRUSELLE, WEESP (NL); Jeroen Karel Wilhelm VAN DEN HURK, WEESP (NL); Kees GROEN, WEESP (NL)

(21) Appl. No.: 19/161,850

(22) PCT Filed: Mar. 11, 2024
(86) PCT No.: PCT/NL2024/050120

§ 371 Date: Sep. 3, 2025

(30) Foreign Application Priority Data
Mar. 10, 2023 (NL) 2034314

(51) Int. Cl. G09G 3/20

(52) U.S. Cl. CPC G09G 3/2096; G09G 2300/0426; G09G 2310/0232; G09G 2360/144; G09G 2380/10; G09G 2380/12

(57) ABSTRACT

The disclosure relates to a combination of an enclosure element of a spatial enclosure, such as a room or cabin, and a display device for displaying visual media content. The display device comprises a display provided with a display area and a controller structured to change the display between two display modes, wherein the display displays on the display area a visual media visually conformal to the environment surrounding and wherein the display device is structured for integration in a manner with or within the enclosure element of the spatial enclosure, such that a transition between the display area and the enclosure element is less than a size of one pixel of the display device. Herewith it is ensured that the human eye of the user does not perceive any differences between the hardware in particular the display of an in-house or in-cabin entertainment system or the interior (the cabin), either in use or in disuse.

### TECHNICAL FIELD

The present disclosure relates to a combination of an enclosure element and a display device structured for integration in a cabin wall of land-based residences and hotels or of land vehicles, a luxury motor or sailing yacht or private airplane. The display device is structured for displaying visual media content on a display with input of sensors to conform the visual media to the surrounding of the display device, such that the visual transition between visual media content and the environment surrounding the display device is reduced.

### BACKGROUND OF THE DISCLOSURE

Transportation vehicles such as land vehicles, luxury yachts and private airplanes but also land-based residences and hotels are specifically designed for the desires and needs of the user. In order to provide a maximum of comfort to the user during their travel and stay durations, high standards are appointed to for example in-house or in-cabin entertainment and/or information systems. In particular, the hardware to display or use video and audio material (also indicated as visual media content) need to of high if not the highest technical requirements in terms of sound and vision quality, and performance.

To provide an optimal comfort, convenience, and efficiency to the user's land vehicles, luxury yachts and private airplanes or at land-based residences and hotels, it is desired that in-house or in-cabin entertainment systems do not create a dominant presence in the environment in which such hardware is installed. Preferably, it is desired that such hardware is invisible or nearly invisible, in both switched-on (active) as in turned-off (inactive) modes.

Accordingly, it is a goal of the present disclosure to provide an improved combination of an enclosure element and a display device ensuring that the human eye of the user does not perceive any differences between the hardware, in particular the display of an in-house or in-cabin entertainment system, and the interior (the cabin), either in use or in disuse.

### SUMMARY OF THE DISCLOSURE

The disclosure relates to a combination of an enclosure element of a spatial enclosure, such as a room or cabin, and a display device for displaying visual media content. The display device comprises a display provided with a display area and an outer periphery such that the display area is visible from inside the spatial enclosure, and a controller structured to cause the display to display visual media content on the display area.

The controller is structured to change the display in a first display mode, wherein the display displays on the display area a visual media visually conformal to the environment surrounding the display device. Additionally, the controller is structured to change the display unit in a second display mode, wherein the display displays on a peripheral portion of the display area adjoining the environment the visual media visually conformal to the environment surrounding the display device and displays on at least one center portion of the display area the visual media content.

Lastly, the combination of an enclosure element and a display device is structured, such that the display of the display device integrates in a manner with or within the enclosure element of the spatial enclosure, having a transition between the display area and the enclosure element being less than a size of one pixel of the display device.

Herewith it is ensured that the human eye of the user does not perceive any differences between the hardware in particular the display of an in-house or in-cabin entertainment system or the interior (the cabin), either in use or in disuse, giving the user in one case the impression that no display device is present in the room and in another that the entire room might be made of display devices.

It should be noted that a spatial enclosure refers to an area that is bounded or defined by physical elements such as walls, fences, or other types of barriers. In this application, it is understood to be an indoor space that is intentionally designed to create a sense of separation or protection from the surrounding environment and may encompass a room or a cabin of a land, water or airworthy vehicle or a room or space of a land-based residence or hotel.

Moreover, the controller of the display device-in both the first display mode and the second display mode-continuously causes the display to conform the visual media visually to the environment surrounding the display device.

Accordingly, the visual media being displayed on the display, which visual media has to visually conform to the environment surrounding the display device is continually adapted or refreshed due to changes in the illumination circumstances of the cabin in which the display of the display device is integrated. These changes are measured with at least one sensor surrounding the display device. These sensors might measure, but are not limited thereto, a light intensity, a light contrast, and/or a light temperature of the environment surrounding the display device.

A pixel is the smallest unit of a digital display. The size of one pixel is thereby determined by the type of display that is used in the combination of the enclosure element and the display device. The pixel size in general may be assumed to be less than 1 mm. In general, it may be assumed more than 50 dots per inch, equaling to less than 500 μm.

In a preferred example the combination of an enclosure element and a display device comprises a first shielding strip at least partly covering the outer periphery of the display.

The presence of a first shielding strip allows for a smooth, invisible to the human eye, transition between the display of the display device and the wall of the spatial enclosure. The first shielding strip might be a separate element or could be part of the wall of the spatial enclosure or could be part of the wall enclosure element. In case the display has an outer periphery housing which is slightly larger than one pixel of the display device, direct integration of the display in an enclosure element will result in a visible discontinuity between the visual media conformal to the surrounding and the surrounding. This is avoided by placing a shielding strip over this edge of the display.

In another preferred example the first shielding strip of the combination of an enclosure element and a display device has a thickness of less than 200 μm.

The thickness of the first shielding strip determines whether the user notably observes or perceives the presence of the first shielding strip and therefore the transition between the enclosure element and the display device or not. The thinner the shielding strip is, the less it can be observed, especially when viewing the display at an angle. Moreover, the preferred thickness is chosen, such that when a user rubs with their hands over the wall element of the spatial enclosure and the display that seemingly no transition is present or noticed.

The thickness of the first shielding strip is also defined such that it is a nominal thickness, such that when surface variations are present in the surface of the enclosure element the nominal thickness can be considered as seen in a cross-section of the shielding strip and will blend into the background of the enclosure element.

In yet another example the combination of an enclosure element and a display device comprises a first shielding strip abutting the outer periphery of the display, such that a flush transition between the first shielding strip and display is achieved or established.

In some cases a display is utilized, which does not have an outer periphery casing (housing) or has a very thin outer periphery casing, such that the distance between the display area and the first shielding strip can be kept below the size of one pixel of the display device. It is then preferred to position the shielding strip adjacent to the display in a flush manner, achieving that no transition between the display area and the shielding strip is noticeable or observable. Again the first shielding strip might be a separate element of could be part of the wall element of the spatial enclosure.

In yet another example a control signal line of the display device electrically connecting the display with the controller extends along the shielding strip facing away the spatial enclosure.

In another example a control signal line of the display device extends perpendicular to the shielding strip facing away the spatial enclosure.

Both above-mentioned examples depend on the type of display device that is used in the combination. The control signal line(s) are positioned such that they and the inactive part (most likely the inactive outer edge) of the display are either oriented in a backwards direction away from the spatial enclosure or extend behind the first shielding strip, such that a user does not observe any discontinuity between the display area and the first shielding strip sic. the enclosure element.

To further enhance the experience of not observing a transition between the display area and the first shielding strip sic. the enclosure element, the shielding strip of the combination of an enclosure element and a display device may by example be provided with a pattern and/or a surface structure.

This pattern can be chosen to match the pattern on the walls of the spatial enclosure and/or to match the surface structure of the display, such that the combination of an enclosure element and a display device blend, overlap and continue into each other. Herewith it is avoided that the user might notice the presence of the display of the display device against its background.

In another example the combination of an enclosure element and a display device comprises a second shielding strip. In particular the second shielding strip of the combination of an enclosure element and a display device may cover the entire display device.

And in another preferred example the second shielding strip of the combination of an enclosure element and a display device is also covering the first shielding strip.

Lastly, in yet another preferred example the second shielding strip of the combination of an enclosure element and a display device is visually transparent.

The previous four examples, wherein the combination of an enclosure element and a display device comprises a second shielding strip, are advantageous in the sense that the second shielding strip can be used to overlay the entire display device with a material having the same gloss, shine and surface characteristics. In such cases whenever a solar ray reflects off on the combination of an enclosure element and a display device, there will be no discontinuity visibility aiding to the desired effect of making the transition between the enclosure element and the display device be unobservable by the user.

In a further example, in the combination of an enclosure element and a display device according to the disclosure, the controller is structured to change the display unit in a third display mode, wherein the display is caused to display no visual media or visual media content.

In a preferred example of the combination of an enclosure element and a display device—in both the first display mode and the second display mode—the controller is structured to cause the display device to continuously conform the visual media visually to the environment surrounding the display device. In particular, the controller is structured to cause the display device to conform the visual media visually to the environment surrounding the display device by detecting a light intensity, a light contrast, and/or a light temperature of the environment surrounding the display device. Accordingly, the visual media being displayed on the display, which visual media has to visually conform to the environment surrounding the display device is continually adapted or refreshed due to changes in the illumination circumstances of the cabin in which the display of the display device is integrated.

Herewith it is avoided that the user might notice the presence of the display of the display device against its background.

In a particular other approach, the controller is structured to cause the display device to conform the visual media visually to the environment surrounding the display device based on at least one pre-stored visual representation of the environment surrounding the display device.

In another functional example of the disclosure, the display device comprises a storage unit structured to store one or more different visual representations of the environment surrounding the display device and wherein the controller is structured to cause the display to conform the visual media being displayed visually to the environment surrounding the display device based on at least one of the pre-stored or real-time captured visual representations of the environment surrounding the display device and based on at least one of the pre-stored visual representations of the environment surrounding the display device based on information detected by a light intensity, a light contrast, and/or a light temperature of the environment surrounding the display device to adjust the visual representation accordingly.

With the above functionalities, it is avoided that the user might notice the presence of the display of the display device against its background.

### BRIEF DESCRIPTION OF THE DRAWINGS

The disclosure will now be discussed with reference to the drawings, which show in:

FIG. 1 a view of a first display mode for reducing the visual transition between the display device and the environment, according to the disclosure;

FIG. 2 a view of a second display mode for reducing the visual transition between the display device and the environment, according to the disclosure;

FIG. 3 example of display integration into the surrounding for reducing the visual transition between the display device and the environment.

FIGS. 4A-B cross-sections of the display integration into the surrounding according to FIG. 3.

FIG. 5 another example of display integration into the surrounding for reducing the visual transition between the display device and the environment.

FIG. 6A-B-C cross-sections of the display integration into the surrounding according to FIG. 5.

FIG. 7 another example of display integration into the surrounding for reducing the visual transition between the display device and the environment.

FIG. 8A-B cross-sections of the display integration into the surrounding according to FIG. 7.

FIG. 9 another example of display integration into the surrounding for reducing the visual transition between the display device and the environment.

FIGS. 10A-B cross-sections of the display integration into the surrounding according to FIG. 9.

FIGS. 11A-B cross-sections of an alternative display integration into the surrounding according to FIG. 9.

FIG. 12 an example of a display used for reducing the visual transition between the display device and the environment.

### DETAILED DESCRIPTION OF THE DISCLOSURE

For a proper understanding of the disclosure, in the detailed description below corresponding elements or parts of the disclosure will be denoted with identical reference numerals in the drawings.

As outlined in the introductory part of the patent application, the disclosure pertains to combinations of enclosure elements and display devices that make sure that the human eye of the user does not perceive any differences between the hardware in particular the display of an in-house or in-cabin entertainment system and the interior (the cabin), either in use or in disuse. In particular, but not exclusively, the disclosure relates to a display device structured for integration in a cabin wall of land-based residences and hotels or of land vehicles, a luxury motor or sailing yacht or private airplane.

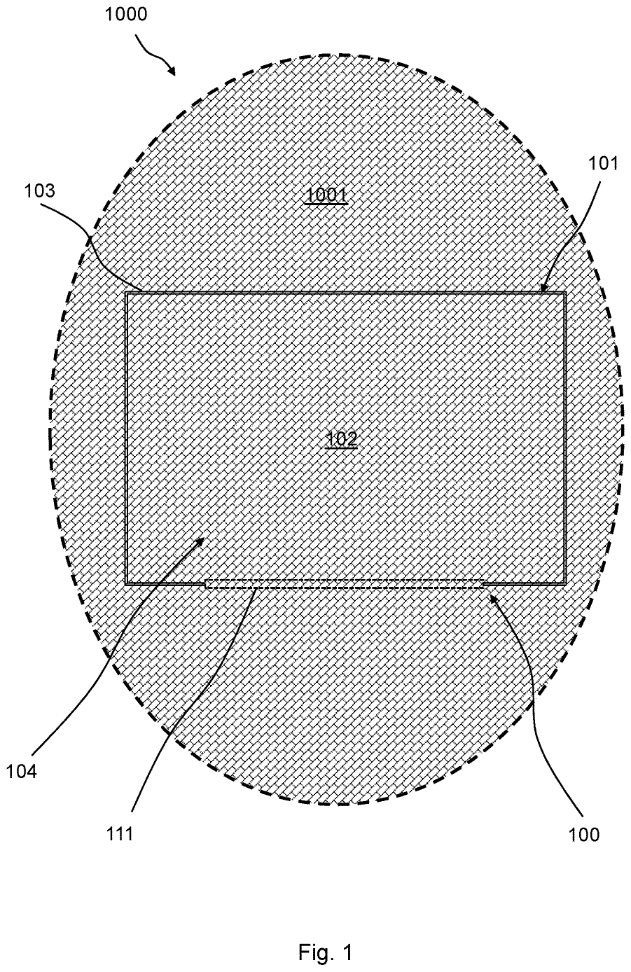

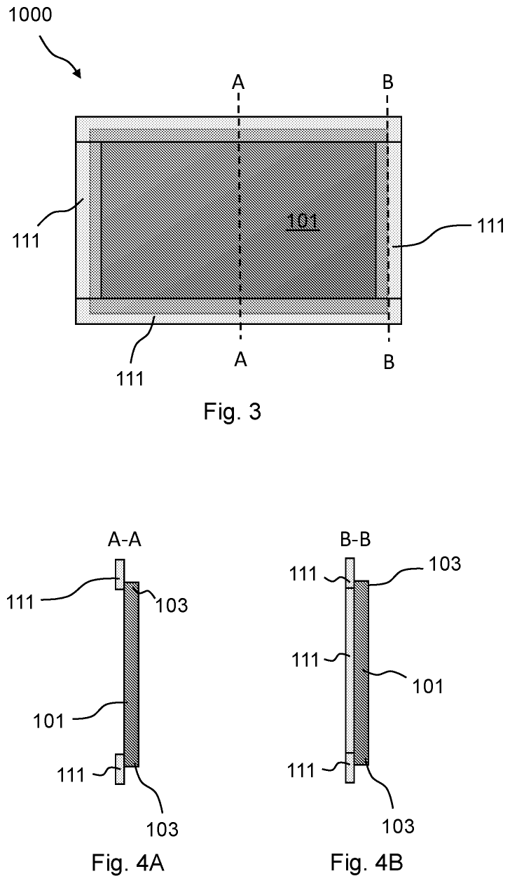

Non-exclusive examples of combinations of enclosure elements and display devices are shown in the Figures, with FIGS. 1, 2, 7, 9, and 12 depicting a structural depiction on component level, whereas FIGS. 3, 4A-B, 5, 6A-B-C, 8A-B, 10A-B, 11A-B depict examples of ways the display device might be physically integrated in such manner in a cabin wall such that only the active part (display area) of the display is visible and thus completely blends into its background. The visual media displayed on either the entire display area or on an area close to the enclosure element is conformal to the surrounding and is adjusted based on input of sensors 130 surrounding the display device.

In the Figures the display device is denoted with reference numeral 100. The displace device 100 is provided with a display 101 which has a display area 102. The displace device 100 is integrated with or within an enclosure element or wall element 1001 of a spatial enclosure 1000, such that the display area 102 is visible from inside the spatial enclosure, and that yet the remainder of the display device 100 is physically integrated within the wall element 1001 in such manner that only the active part of the display 102 is visible and thus completely blends into its background.

Reference numeral 103 depicts the physical outer dimension of the display device 100 being integrated in the wall element 1001.

It should be noted that that a spatial enclosure 1000 refers to an area that is bounded or defined by physical elements such as walls, fences, or other types of barriers. In this application, it is understood to be an indoor space that is intentionally designed to create a sense of separation or protection from the surrounding environment and that a spatial enclosure 1000 should be understood as encompassing a room or a cabin of a land, water or airworthy vehicle or a room or space of a land-based residence or hotel.

The display device 101 can be any type of display but is preferably chosen from the group consisting of LCD, LED, plasma, QLED, OLED and/or 4K UHD.

The display device 100 furthermore incorporates a controller 110 structured control the display 101 for displaying visual media content on the display area 102. The controller 110 is linked with the display 101 via a display data control line 141, which connects the controller 110 with the display 101 by means of a display data bus 140.

In this disclosure, visual media content may refer to any type of media or content that is primarily visual in nature, meaning that it is meant to be seen rather than read or heard. This can include still photographs, drawings, paintings, illustrations, graphic designs, animations, and videos, including movies. An image is a single picture or a photograph, which captures a moment in time and displays a single frame of visual information, whereas a video or movie, on the other hand, is a sequence of images displayed rapidly in succession, creating the illusion of motion. It is a series of frames that when played in a specific order, create a moving image with sound.

Within the framework of the present disclosure, the visual media content to be displayed on the display area 102 of the display device 100 can be used for a wide range of purposes, such as entertainment, communication, education, and advertising, and can be created and viewed in various formats.

Accordingly, in order to properly display a video or movie, the display device 100 may also incorporate one or more speakers, which may be integrated in the display device 100 or elsewhere within the spatial enclosure 1000. Alternatively, the display device 100 itself is not provided with speakers, but the controller 110 may be structured to send audio signals to a multimedia sound system implemented elsewhere within the spatial enclosure 1000.

The controller 110 is structured as a computer processing unit 110 and is structured to execute a computer implemented method for operating the display device 100, in particular for displaying visual media content on the display area 102 of the display 101. In particular, the controller 110 is capable of reducing the visual transition between visual media content displayed on the display area 102 and the environment 1001 surrounding the display device 100.

In a first display mode of the display device, as shown in FIG. 1, the controller 110 is structured to cause the display 101 to display visual media content on the display area 102, and to change the display 101 in the first display mode, wherein the display 101 displays on the display area 102 a visual media denoted with reference numeral 104. In the first display mode—the visual media 104 is visually conformal to the environment 1001 surrounding the display device 100.

In particular, the controller 110 causes the display 101 to display visual media content 104 which has exactly the same appearance as the visual appearance of the enclosure or wall element 1001 of the spatial enclosure 1000 surrounding the display device 100.

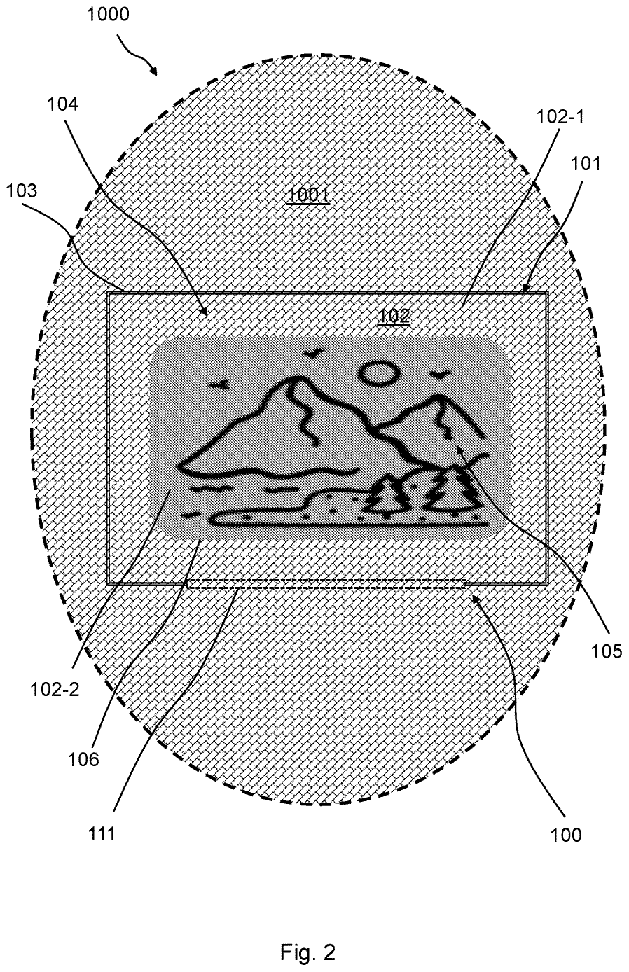

According to the disclosure, the controller 110 is structured to change the display unit 100 from the first display mode into a second display mode, which mode is shown in FIG. 2. In the second display mode, the controller 110 causes the display 101 to display on a peripheral portion 102-1 of the display area 102 adjoining the environment 1001 the visual media 104 visually conformal to the environment 1001 surrounding the display device 100 and displays on at least one center portion 102-2 of the display area 102 visual media content 105, which is different from the visual media 104. In the example shown in FIG. 2, the visual media content 105 can be still photographs, or other visual content such as an animation or a video, such as a movie or television broadcast.

The visual appearance of the visual media content 105 displayed on the center portion 102-2 of the display area 102 is completely different from the visual media 104 displayed on the peripheral portion 102-1 of the display area 102 adjoining the environment 1001, the latter visual media 104 still being visually conformal to the environment 1001 surrounding the display device 100.

Herewith a display 101 of a display device 100 is obtained which is physically integrated within a wall element 1001 in such manner that only the active part or display surface 102 of the display 101 is visible. In an example, the display 101 might be embedded flush within the wall element 1001 or the edge might be covered with a first shielding strip 111 to reduce the transition between the enclosure element and the display area to less than one pixel of the display device. Moreover, in the first display mode, the controller 110 causes the display 101 to display visual media content 104 conformal to the visual appearance of the surrounding wall element 1001. As such, the display device 100 completely blends into its background 1001 and becomes invisible to a user 200 being present in the spatial enclosure 1000 (room, cabin, etc.). In particular, in the first display mode, it is ensured that the human eye of the user 200 does not perceive any differences between the hardware in particular the display 101 of the in-house or in-cabin entertainment system and the interior (the cabin), either in use or in disuse.

In the second display mode of FIG. 2, as the display 101 displays on the center portion 102-2 the visually different visual media content 105 and displays on the peripheral portion 102-1 surrounding the center portion 102-2 and adjoining the environment 101 the visual media 104 which is visually conformal to the visual appearance of the environment 1001, the human eye of the user 200 does not perceive any differences between the display device 100 in particular the display 101 and its surrounding environment 1001 and in particular will not notice the physical transition between the display device 100 and the wall element 1001, sic. will not notice the outer periphery 103 of the display 101.

The user 200 will visually be drawn to the optical transition 106 between the peripheral portion 102-1 depicting the visual media 104 and the center portion 102-2 depicting the visual media content 105, and as this optical transition 106 is also part of the display area 102, the user 200 will be tricked as he or she will not observe a physical transition at the optical transition 106, which physical transition is in fact located at the outer periphery 103. Accordingly, the visual transition between the display 101 and the environment 1001 surrounding the display device 110 is visually reduced.

It should be noted, that in the second display mode, the controller 110 may cause the display 101 to display on the peripheral portion 102-1 of the display area 102 adjoining the environment 1001 the visual media 104 visually conformal to the visual appearance of the environment 1001 surrounding the display device 100 and to display on multiple center portions (not shown), etc. of the display area 102 various visual media contents, etc., which are all different from the visual media 104 and optionally also different from each other.

Another aspect of the display device is a third display mode, wherein the display 101 of the display device 100 is either turned off and thus displays no visual media 104 or visual media content 105 or is turned on and the entire display area 102 shows visual media content 105.

In both the first display mode (FIG. 1) and the second display mode (FIG. 2), the controller 110 of the display device 100 is structured to continuously cause the display 101 to display the visual media 104 in a conformal manner visually to the visual appearance of the environment 1001 surrounding the display device 100.

Accordingly, the visual media 104 being displayed on the display 101, which visual media has to visually conform to the visual appearance of the environment 1001 surrounding the display device 100 is continually adapted or refreshed due to changes in the illumination circumstances of the cabin 1000 in which the display 101 of the display device 100 is integrated.

In one example of the above functionality, the controller 110 of the display device 100 causes the display 101 to conform the visual media 104 being displayed visually to the visual appearance of the environment 1001 surrounding the display device 100 by detecting a light intensity, a light contrast, and/or a light temperature of the environment surrounding the display device.

In order to execute this functionality, the display device 100 exhibits preferably at least one sensor 130 surrounding the display device 100, which sensor 130 is structured to generate a signal 130a based on a light intensity, a light contrast, and/or a light temperature of the environment 1001 of the display device.

In response to the environmental characteristic 130z being detected by the at least one sensor 130, the sensor 130 generates and outputs signals 130a to the controller 110, which causes the display 101 to adjust the visual media 104 being displayed on the display 101 such that the visual media 104 continues to conform visually to the changed visual appearance of the environment 1001 surrounding the display device 100. Accordingly, as the visual appearance of the environment 1001 may change over time due to changes in light intensity, light contrast, and/or light temperature as well as due to the light changes during the day (such as dawn, dusk, clouds in the sky, and other weather phenomenon) the sensor 130 will detect such changes and instruct the controller to adapt the visual media 104 such that it continues to conform to the changed visual appearance of the environment 1001. Accordingly, the human eye of the user 200 will still not perceive any differences between the display 101 and its surrounding environment 1001 and in particular will not notice the physical transition between the display device 100 and the wall element 1001, sic. will not notice the outer periphery 103 of the display 101.

In another functional example of the disclosure, the display device 100 comprises a storage unit 120, which is connected with the controller 110 via a signal line 121, which may be a hardware control line or a wireless connection line. The storage unit 120 can be any type of storage, such as a (solid-state) hard drive, a USB drive, or a (digital) optical disc. The storage unit 120 may comprise a database or other type of storage format, in which one or more different visual representations 204₁-204₂- . . . -204₅-204₆- . . . 204ₙ of the environment 1001 surrounding the display device 100 are stored.

The visual representations 204₁-204₂- . . . -204₅-204₆- . . . 204ₙ may in be images of the wall element 1001 in which the display device 100 is mounted sic. installed, for example visual representations 204ₙ obtained at different lighting settings (such as dawn, dusk, clouds in the sky, and other weather phenomenon, etc.). Alternatively, the visual representations 204ₙ may be visual representations of different environments 1001, e.g. of different rooms, halls, wall elements etc. of the land vehicle, luxury yacht, private airplane, or land-based residence or hotel in which the the display device 100 is mounted sic. installed. The visual representations 204₁-204₂- . . . -204₅-204₆- . . . 204ₙ may be generated in advance, prior to the installation of the display device 100, or may be live captured imagery, generated through suitable image capturing means such as a camera and uploaded in the storage unit 120 for use by the display device 100/controller 110.

The controller 110 is structured to cause the display 101 to conform the visual media 104 being displayed on the display area 102 visually to the environment 1001 surrounding the display device 100 based on at least one of the pre-stored visual representations 204₁-204₂- . . . -204₅-204₆- . . . 204ₙ of the environment 1001 surrounding the display device 100. Also here, the controller 110 may address the storage unit 120 via the signal line 121 and select one of the pre-stored visual representations 204₁-204₂- . . . -204₅-204₆- . . . 204ₙ based on the environmental characteristic 130z detected by the sensor 130. In particular, the sensor 130 generates and outputs a signal 130a to the controller 110 in response to the environmental characteristic 130z being detected.

The signal 130a, which can be considered as being representative for the actual visual appearance of the environment 1001, can be compared by the controller 110 with the pre-stored visual representations 204₁-204₂- . . . -204₅-204₆-204ₙ and based on the comparison the controller 110 will select the pre-stored visual representation 204ₙ which—when displayed on the display 101 as the visual media 104—has the best or most optimal match with the detected, actual visual appearance of the environment 1001.

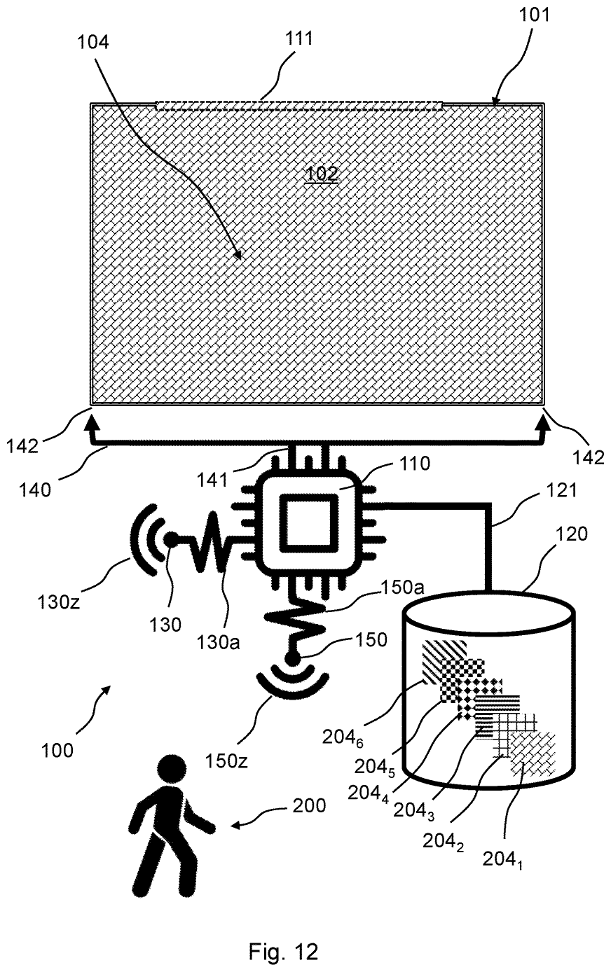

In the example shown in FIG. 12, the pre-stored visual representation 2041 has the same visual appearance as the visual appearance of the wall element 1001 as the decorative pattern correspond with each other. Accordingly, the pre-stored visual representation 2041 is chosen by the controller 110 in order to control the display 101 to display the same pattern appearance as the visual media 104 on the active display area 102.

Additionally, the pre-stored visual representations 204₁-204₂- . . . -204₅-204₆- . . . 204ₙ can be expanded or improved with additional light reflection data. To ensure that the ‘digital representation’ of the visual media 104 on the active display area 102 constantly adapts to the lighting conditions in the relevant room, the pre-stored visual representations 204₁-204₂- . . . -204₅-204₆- . . . 204ₙ can be supported by so-called ‘light reflection fingerprints’ of the various types of environment 1001 surrounding the display device 100. This ‘fingerprint’ is created by measuring how the material of the environment 1001 surrounding the display device 100 reflects and absorbs light.

The information from these ‘fingerprints’ are likewise pre-stored in the controller 110 and can be combined with either the pre-stored visual representations 204₁-204₂- . . . -204₅-204₆- . . . -204ₙ and/or with the real-time measurements of at least four light sensors 130 positioned around the display device 100. Based on this signal output it is possible to adjust the ‘digital representation’ in real time.

Also with this functionality, it is avoided that the user 200 might notice the presence of the display 101 of the display device 100 against its background 1001.

In both functionalities described above, in order to improve the invisibility of the physical transition 103 between the display device 100 and the wall element 1001, the visual media 104 to be displayed on the display 101 may be provided with a visual or image-determining pattern being equal to the visual appearance of the outer wall element 1001 surrounding the display 101, which overlaps, blends and continues into the specific pattern of the visual appearance of the wall element 1001.

Accordingly, with the above functionalities, the controller 110 is able to match the visual media 104 to be displayed on the display 101 with the visual appearance of the outer wall element 1001 surrounding the display 101. The matching may be adjusted due to any changes in environmental characteristics 130z being detected, such as light intensity, light contrast, and/or light temperature and/or light changes during the day yet also the material characteristics of the material surface of the outer wall element 1001 are considered. Accordingly, the controller 110 is capable of re-creating the same surface structure of the outer wall element 1001 (e.g. the appearance of the surface roughness and gloss level) as part of the visual media 104 to be displayed.

In particular, the reflection factor and/or gloss level of the material forming the surface of the outer wall element 1001 disposed around the display device 100 can be considered, as one of the environmental characteristics 130z or being part of the environmental characteristic 130z and incorporated into the visual media 104 to be display on the display surface 102. In other words, when the wall element 1001 is composed of construction panels made from wood having a certain surface roughness and mattness level, the corresponding environmental characteristics 130z can be detected and processed by the controller 110, and/or a corresponding visual representations 204ₙ can be generated (in advance or in real time), and the matching visual media 104 having a similar mattness is generated and displayed on the display. Similarly, when the outer wall element 1001 is made from high-gloss marble, visual media 104 having the same matching high-gloss finish can be created and displayed.

Optionally, the reflection factor and/or gloss level can be used as a static environmental characteristics 130z for the visual media 104 to be displayed based on the reflection factor and/or gloss level of the surrounding outer wall element 1001.

Although the physical, inactive outer dimension (periphery) 103 of the display device 100 is being integrated in the wall element 1001 and thus not considered visible to the user 200, a shielding strip or adjacent wall element 111 can be used to cover the outer periphery 103. In FIG. 12, the first shielding strip 111 is depicted, for illustrative purposes, as partially shielding the outer periphery 103, however it is clear that the first shielding strip 111 covers the complete outer periphery 103 of the display 101 through overlapping.

As the optional shielding strip 111 may be provided with a visual or image-determining pattern being equal to the visual appearance of the outer wall element 1001 surrounding the display 101, the outer periphery 103 becomes invisible and blends against the exterior background of the wall element 1001. It is even possible to provide the visual image-determining pattern of the first shielding strip 111 such that it overlaps, and blends and continues into the specific pattern of the visual appearance of the wall element 1001. The first shielding strip 111 may even be provided with the same surface structure of the wall element 1001 surrounding the display 101.

As a further functionality, the display device 100 may comprise a proximity sensor 150 for detecting the presence (e.g. entrance) of a user 200 in the room 1000 in which the display device 100 is installed. The motion or presence 150z within the room 1000 is detected by the proximity sensor 150, which in turn generates a motion or proximity detection signal 150a, which signal 150a is received by the controller 110 for example for activating the display device 100 from its third display mode to its first display mode (shown in FIG. 1) or second its second display mode (shown in FIG. 2).

The storage unit 120, the sensor 130, and the proximity sensor 150 may be connected and controlled by the controller 110 using suitable hardware signal lines, and corresponding control circuitry and alternatively using wireless control circuitry.

In FIG. 3 (in combination with cross-sectional views of FIGS. 4A and 4B taken along the lines A-A and B-B of FIG. 3) different ways to integrate the display device 101 into the enclosure element 1001 are shown. In a first embodiment a first shielding strip 111 is positioned covering the edge of the display in an overlapping manner and follows the outer periphery 103 of the display, such that when a display device 100 is used exhibiting an inactive outer edge 103, the appearance of the wall 1001 or the surrounding can be extended into the active display area. When designed this way, the transition between the enclosure element 1001 and the display area 101 can be reduced to be less than one pixel of the display device 100.

The material of the first shielding strip 111 may be chose to match or leverage the material properties of the wall element 1001 and those of the display device 101. This way, the visual transition has become even less observable due to a similar response of all the materials used upon touch or light glare. The material of the first shielding strip 111 may be chosen to be made of wood, paper, metal, plastic, ceramic, cement, stone or the like.

Furthermore, this first shielding strip 111 may be provided with a visual or image-determining pattern being equal to the visual appearance of the outer wall element 1001 surrounding the display 101, thereby the outer periphery 103 becomes invisible and blends against the exterior background of the wall element 1001 (see FIG. 4A). It is even possible to provide the visual image-determining pattern of the first shielding strip 111 such that it overlaps, and blends and continues into the specific pattern of the visual appearance of the wall element 1001. The first shielding strip 111 may even be provided with the same surface structure of the wall element 1001 surrounding the display 101.

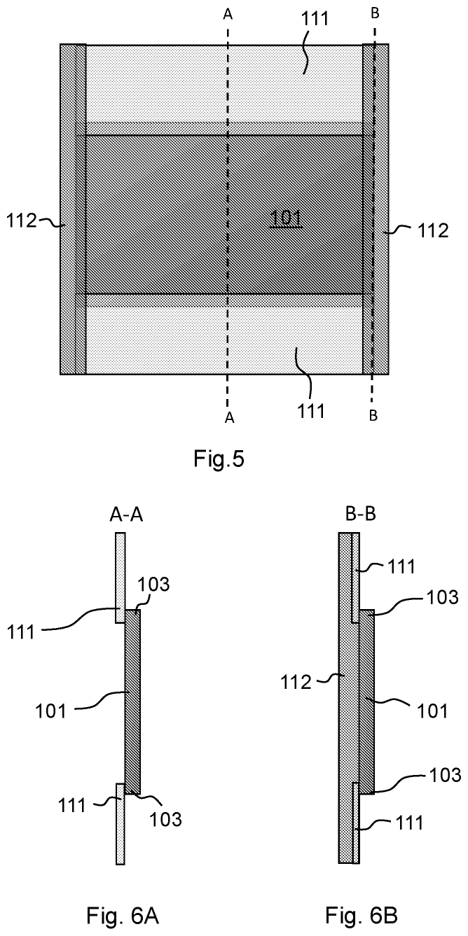

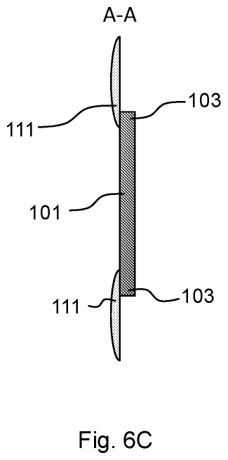

In another embodiment, as depicted in FIG. 5 (in combination with cross-sectional views of FIGS. 6A and 6B taken along the lines A-A and B-B of FIG. 5), the combination of enclosure element 1001 and display device 100 may comprise a second shielding strip 112 covering (part of) the first shielding strip 111 and/or part of the display device 101.

The second shielding strip 112 may be chosen to be visually transparent and to even cover the entire combination of enclosure element 1001 and display device 100. This way reflections and solar glare on the surface of the wall element 1001 comprising the display device 101 will respond uniformly and evenly. Additionally, when a user feels with their hands over the assembly, no edge or notch can be detected, which all aids towards the invisibility of the transition between the enclosure element and the display device. The material of the second shielding strip 112 may thus be chosen to be glass, plastic, or the like.

In another example the first shielding strip 111 is very thin, being less than 200 μm, such that when a human hand touches or feels over the device, it does not observe or perceive the transition of the display area 102 to the first shielding strip 111 to the wall of the spatial enclosure 1001. Alternatively, as shown in FIG. 6C, the shape of the strip can be chosen such that there is a smooth transition when going from the display area 102 to the first shielding strip 111. In this particular example, the shielding strip is provided with a rounded edge. Herewith a perception is created that the surface structure of the shielding strip 111 is part of the overall surface structure of the enclosure element 1001.

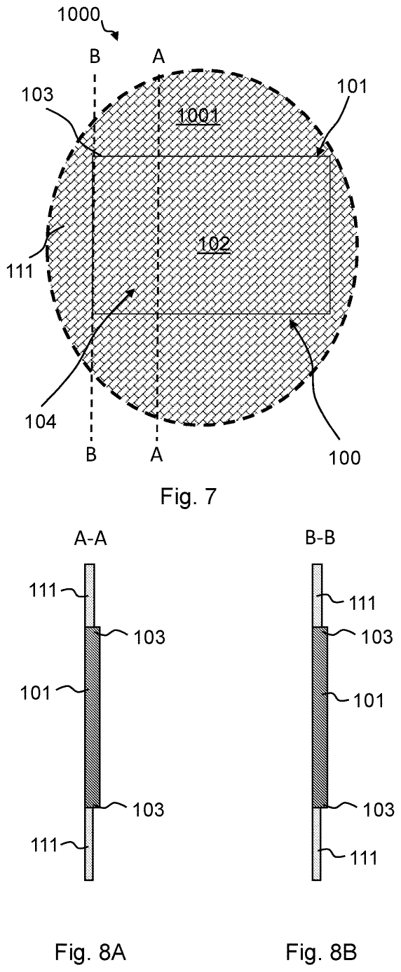

In another embodiment of the disclosure as shown in FIG. 7 (in combination with cross-sectional views of FIGS. 8A and 8B taken along the lines A-A and B-B of FIG. 7). The first shielding strip 111 is positioned in an abutting manner to the display device 100. This design may be chosen when the display 101 of the display device 100 is edgeless or has an inactive edge (outer periphery 103) which is smaller than one pixel of the display device 100. In these examples the display 101 and first shielding strip 111 can be positioned flush to each other, such that when a user touches or feels over the combination no transition can be observed.

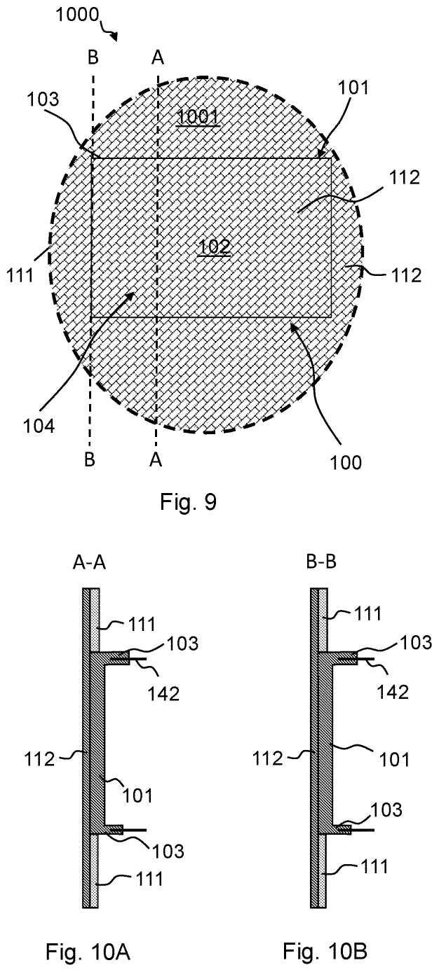

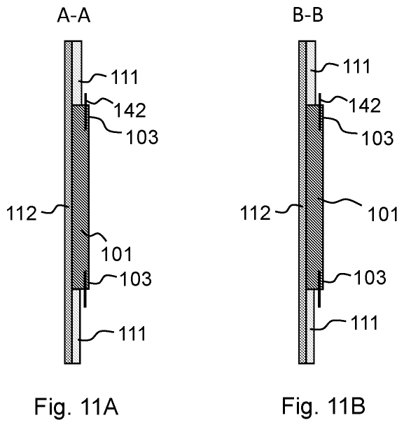

In some examples the inactive edge 103 of the display 101 can be hidden behind the first shielding strip 111, while still being flush, as shown FIG. 9 (in combination with cross-sectional views of FIGS. 10A and 10B or FIGS. 11A and 11B taken along the lines A-A and B-B of FIG. 9) by either configuring the inactive part 103 protruding perpendicularly outward away from the display 101 or by placing the inactive part 103 along the display 101 behind the first shielding strip 111, such as the display data control line 141 and display data bus 140 and the control signal line 142.

Similarly as disclosed before, a second shielding strip 112 may be used to cover the entire combination of enclosure element and display device 1000 aiding to not feeling a transition and to having a similar response to solar glare and/or reflections.

### LIST OF REFERENCE NUMERALS USED

100 display device
101 display
102 display area/display surface
103 periphery of display
104ₙ visual media visually conformal to the environment
105ₙ visual media content (different from visual media 104ₙ)
102-1 peripheral portion of the display area adjoining the environment
102-2ₙ center portion of the display area
106ₙ transistion between visual media 104ₙ and visual media content 105ₙ
110 controller deze ontbreekt in de tekening(en)
111 first shielding strip for display
112 second shielding strip for display
120 storage unit
121 storage unit control line, wired or wireless
130 sensor (light intensity, light contrast, and/or a light temperature)
130a signal generated by sensor 130
130z environmental characteristic detected by sensor 130
140 display data bus
141 display data control line
142 control signal line
150 proximity sensor
150a signal generated by proximity sensor 150
150z motion or presence detected by proximity sensor 150
200 person/user
204ₙ pre-stored or live captured visual representations of the environment
1000 spatial enclosure, such as a room or cabin
1001 enclosure element of spatial enclosure

1. A combination of an enclosure element of a spatial enclosure, such as a room or cabin, and a display device for displaying visual media content, the display device comprising:
a display provided with a display area and an outer periphery such that the display area is visible from inside the spatial enclosure; and
a controller structured to cause the display to display visual media content on the display area, wherein
the controller is structured to change the display in a first display mode, wherein the display displays on the display area a visual media visually conformal to the environment surrounding the display device and
to change the display in a second display mode, wherein the display displays on a peripheral portion of the display area adjoining the environment the visual media visually conformal to the environment surrounding the display device and displays on at least one center portion of the display area the visual media content and
wherein the display is structured for integration in a manner with or within the enclosure element of the spatial enclosure, such that a transition between the display area and the enclosure element is less than a size of one pixel of the display device.

2. The combination of an enclosure element and the display device according to claim 1, wherein the enclosure element comprises a first shielding strip at least partly covering the outer periphery of the display.

3. The combination of an enclosure element and a display device according to claim 2, wherein the first shielding strip has a thickness of less than 200 μm.

4. The combination of an enclosure element and a display device according to claim 1, wherein the enclosure element comprises a first shielding strip abutting the outer periphery of the display, such that a flush transition between the first shielding strip and the display is achieved.

5. The combination of an enclosure element and a display device according to claim 4, wherein a control signal line of the display device electrically connecting the display with the controller extends along the first shielding strip facing away from the spatial enclosure.

6. The combination of an enclosure element and a display device according to claim 5, wherein the control signal line of the display device extends perpendicular to the first shielding strip facing away the spatial enclosure.

7. The combination of an enclosure element and a display device according to claim 2, wherein the first shielding strip is provided with a pattern and/or a surface structure.

8. The combination of an enclosure element and a display device according to claim 2, further comprising a second shielding strip.

9. The combination of an enclosure element and a display device according to claim 8, wherein the second shielding strip is covering the entire display device.

10. The combination of an enclosure element and a display device according to claim 9, wherein the second shielding strip is covering the display abutting first shielding strip.

11. The combination of an enclosure element and a display device according to claim 8, wherein the second shielding strip is visually transparent.

12. The combination of an enclosure element and a display device according to claim 1, wherein the controller is structured to change the display in a third display mode, wherein the display is caused to display no visual media or visual media content.

13. The combination of an enclosure element and a display device according to claim 1, wherein—in both the first display mode and the second display mode—the controller is structured to cause the display device to continuously conform the visual media visually to the environment surrounding the display device.

14. The combination of an enclosure element and a display device according to claim 13, wherein the controller is structured to cause the display device to conform the visual media visually to the environment surrounding the display device by detecting a light intensity, a light contrast, and/or a light temperature of the environment surrounding the display device.

15. The combination of an enclosure element and a display device according to claim 13, wherein the controller is structured to cause the display device to conform the visual media visually to the environment surrounding the display device based on at least one pre-stored visual representation of the environment surrounding the display device.

16. The combination of an enclosure element and a display device according to claim 15, wherein the display device comprises a storage unit structured to store one or more different visual representations of the environment surrounding the display device and wherein the controller is structured to cause the display to conform the visual media being displayed visually to the environment surrounding the display device based on the at least the pre-stored visual representation of the environment surrounding the display device and based on information detected by a light intensity, a light contrast, and/or a light temperature of the environment surrounding the display device to adjust the visual representation accordingly.
